(19) United States
(12) Patent Application Publication
(10) Pub. No.: US 2006/0077585 A1
(43) Pub. Date: Apr. 13, 2006

(54) Data storage cartridge and system with tamper and damage record sensors

(76) Inventor: Scott G. Larson, Maplewood, MN (US)

Correspondence Address: Imation Corp., PO Box 64898, St. Paul, MN, 55164-0898, US

(21) Appl. No.: 10/964,858

(22) Filed: Oct. 13, 2004

(51) Int. Cl. G11B 19/02; G11B 23/02

(52) U.S. Cl. 360/69; 360/132

(57) ABSTRACT

A data storage cartridge is described. The data storage cartridge includes a housing, a data storage medium, a memory module, and at least one sensor. The housing defines first and second housing sections that are reciprocally mated to form an enclosed region. The data storage medium and the memory module are disposed within the enclosed region, and the sensor(s) is/are disposed within the enclosed region and electrically coupled to the memory module. In this regard, sensor(s) is/are configured to sense a cartridge event and the memory module communicates with the sensor(s) to record the sensed cartridge event(s).

### THE FIELD OF THE INVENTION

The present invention relates to a data storage cartridge, and more particularly, to a data storage cartridge capable of sensing events and generating a performance record.

### BACKGROUND OF THE INVENTION

Data storage cartridges have been used for decades in the computer, audio, and video fields. The data storage cartridge continues to be a popular device for recording large volumes of information for subsequent retrieval and use.

A data storage cartridge generally consists of an outer shell or housing maintaining a data storage medium. In this regard, the data storage medium can include magnetic data storage tape, magnetic discs, optical tapes, and optical discs. One common example of a data storage cartridge includes a housing maintaining at least one tape reel assembly and a length of magnetic storage tape. The storage tape is wrapped about a hub portion of the tape reel assembly and is driven through a defined path by a tape drive system. The housing normally includes a separate cover and a separate base. Together, the cover and the base form an opening (or window) at a forward portion. Access to the storage tape by a read/write head is initiated via insertion of the data storage tape cartridge into a tape drive. The interaction between the storage tape and head occurs within the housing for a mid-tape load design. Conversely, the interaction between the storage tape and head occurs exterior the housing for a helical drive design. Where the tape cartridge/drive system is designed to direct the storage tape away from the housing, the data storage tape cartridge normally includes a single tape reel assembly employing a leader block design. Alternately, where the tape cartridge/drive system is designed to provide head/storage tape interaction within the housing, a dual tape reel configuration is typically employed.

Regardless of the number of tape reel assemblies associated with a particular data storage tape cartridge, each cartridge includes at least one strand of magnetic storage tape. In this regard, the magnetic storage tape includes a base substrate (typically a polymeric film, for example polyethylene naphthalate) coated on at least one side with a magnetic dispersion. The magnetic dispersion, when dry, is sensitive to magnetic fields and is configured to magnetically record information. With this in mind, the magnetic storage tape, in addition to being receptive to magnetically written data, can also be magnetically interfered with. For example, strong magnetic fields can destroy, or write over, magnetic information stored on the storage tape. Moreover, abusive handling of the data storage tape cartridge can damage portions of the cartridge or the magnetic coating on the storage tape. To this end, data stored on the storage tape can be lost (i.e., made irretrievable) when the cartridge or the storage tape is damaged.

In some cases the damage to the storage tape and/or cartridge is not apparent to the user. In particular, data is said to be inadvertently lost when the magnetic storage tape becomes damaged without the knowledge of the end-user or consumer. For example, a consumer could record data onto the storage tape and unknowingly place the cartridge in a strong magnetic field, for example, next to a magnet. In this scenario, it is possible that the data stored on the storage tape could be erased by the strong magnetic field such that the consumer would be oblivious to the fact that the data had been lost. At a later time, when the consumer attempts to retrieve the once stored data, s/he will discover that the data is damaged or unretrievable.

In addition, data storage tape cartridges can also be damaged during transportation, storage, and through end-user abuse. For example, the storage tape (and its data storing capacity) can be damaged through exposure to high temperatures, sudden shock due to dropping, and cartridge tampering. In this regard, what is initially a high quality data storage tape cartridge meeting all industry standards later becomes damaged or destroyed due to improper transportation, storage or handling. With this in mind, the user has an interest in establishing that the data storage tape cartridge is functional and ready for future data storage uses.

In other instances, the manufacturer produces and delivers a data storage tape cartridge meeting all industry standards, and the cartridge later becomes damaged or destroyed through abuse or neglect of the cartridge by the end-user. For example, tampering with the housing components, dropping the cartridge, opening the cartridge housing to expose the data storage tape, etc., can all damage the information storage capacity of the storage tape. To this end, manufacturers desire to establish that the data storage tape cartridge was manufactured in compliance with industry standards and delivered to the consumer in a serviceable condition.

With the above discussion in mind, manufacturers and consumers have an expectation that data storage cartridges will be useful and operable in storing data. Manufacturers desire verification of the life cycle history of the data storage cartridge. Likewise, consumers desire assurance that the data storage cartridge meets industry standards, and once written to, is operable such that the data is retrievable. Therefore, a need exists for manufacturers and consumers to compile and access a record of the data storage cartridge performance and use history.

### SUMMARY OF THE INVENTION

One aspect of the present invention is related to a data storage cartridge. The data storage cartridge includes a housing, a data storage medium, a memory module, and at least one sensor. The housing defines first and second housing sections that are reciprocally mated to form an enclosed region. The data storage medium is disposed within the enclosed region. The memory module is disposed within the enclosed region, and the sensor(s) is/are disposed within the enclosed region and electrically coupled to the memory module. In this regard, sensor(s) is/are configured to sense a cartridge event and the memory module communicates with the sensor(s) to record the sensed cartridge event.

Another aspect of the present invention is related to a system for generating a performance record for a data storage device. The system includes a data storage cartridge and a reader. The data storage cartridge includes a housing, a data storage medium, a memory module, and at least one sensor. In this regard, the housing defines first and second housing sections, the housing sections reciprocally mated to form an enclosed region. The data storage medium and the memory module are disposed within the enclosed region. The sensor(s) is/are disposed within the enclosed region and is/are electrically coupled to the memory module to sense a cartridge event. To this end, the memory module is configured to store the sensed cartridge event in the performance record, and further wherein the reader communicates with the memory module to read the performance record.

Yet another aspect of the present invention is related to a method of generating a performance record for a data storage device. The method includes providing a data storage cartridge. In this regard, the data storage cartridge includes a housing, a data storage medium, a memory module, and at least one sensor. The housing defines first and second housing sections, the housing sections reciprocally mated to form an enclosed region. The data storage medium and the memory module are disposed within the enclosed region. The sensor(s) is/are disposed within the enclosed region and is/are electrically coupled to the memory module. The method additionally includes sensing a cartridge event with the at least one sensor, and storing the sensed cartridge event in the memory module as data in the performance record. The method ultimately includes reading the performance record data with a reader located exterior to the data storage tape cartridge.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective, exploded view of a data storage tape cartridge showing a memory module and sensors according to one embodiment of the invention;

FIG. 2 is a top view of a second housing section including the memory module and sensors shown in FIG. 1;

FIG. 3 is a top view of a memory module and electrical connectors 78 extending therefrom according to one embodiment of the present invention; and

FIG. 4 is a system showing a reader accessing tamper and damage record data stored in a memory module of a data storage tape cartridge according to one embodiment of the present invention.

### DETAILED DESCRIPTION OF THE PREFERRED EMBODIMENTS

The utility and advantages of the various embodiments of the present invention can be implemented in data storage cartridges generally. In this regard, the general data storage cartridge includes a housing defining an enclosed region, a data storage medium and a memory module disposed within the enclosed region, and at least one sensor disposed within the enclosed region and electrically coupled to the memory module. Specific examples of useful data storage cartridges, data storage media, and memory modules are described below. The specific examples illustrate only some of the useful embodiments of the present invention, as will be readily apparent to any person skilled in the art of data storage cartridges. The following examples are, therefore, illustrative only and are not intended to delimit the scope of the invention.

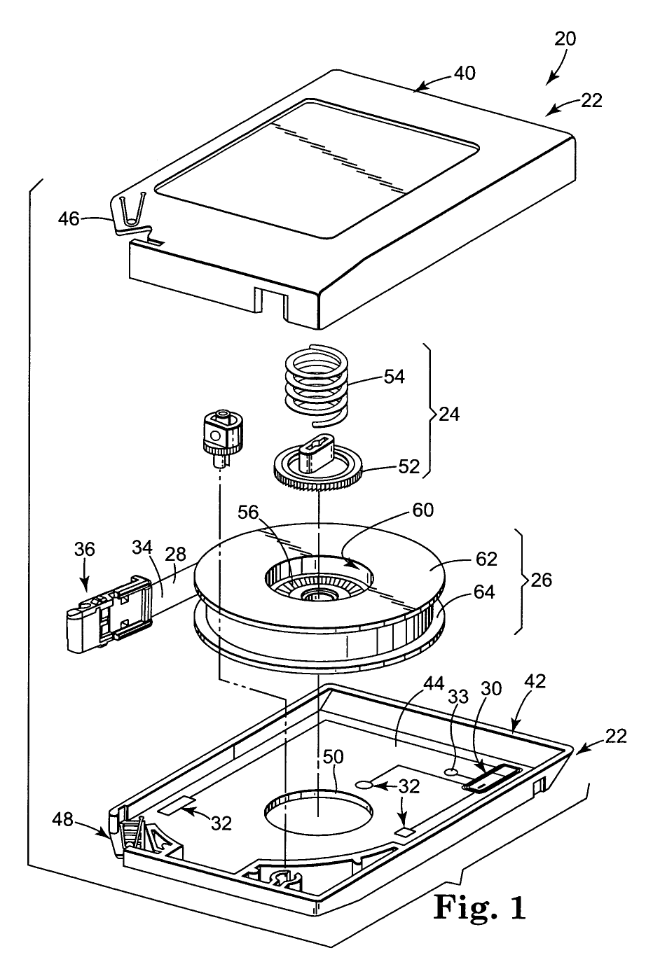

With the above discussion in mind, an exemplary data storage cartridge according to one embodiment of the present invention is illustrated in the form of a single reel data storage tape cartridge and shown at 20 in FIG. 1. Generally, the data storage tape cartridge 20 includes a housing 22, a brake assembly 24, a tape reel assembly 26, a storage tape 28, a memory module 30, one or more sensors 32, and a power source 33 for energizing the memory module 30 and/or the one or more sensors 32. The tape reel assembly 26 is disposed within the housing 22. The storage tape 28, in turn, is wound about the tape reel assembly 26 and includes a leading end 34 attached to a leader block 36. As a point of reference, while a single reel data storage tape cartridge is shown, the present invention is equally applicable to other cartridge configurations, such as dual reel cartridges.

The housing 22 is sized for insertion into a typical tape drive (not shown). Thus, the housing 22 exhibits a size of approximately 125 mm×110 mm×21 mm, although other dimensions are equally acceptable. With this in mind, the housing 22 defines a first housing section 40 and a second housing section 42. In one embodiment, the first housing section 40 forms a cover, and the second housing section 42 forms a base. It is understood that directional terminology such as “cover,” “base,” “upper,” “lower,” “top,” “bottom,” etc., is employed throughout the Specification to illustrate various examples, and is in no way limiting.

The first and second housing sections 40 and 42, respectively, are sized to be reciprocally mated to one another to form an enclosed region 44 and are generally rectangular, except for one corner 46 that is preferably angled to form a tape access window 48. The tape access window 48 forms an opening for the storage tape 28 to exit the housing 22 when the leader block 36 is removed from the tape access window 48 and threaded to a tape drive system (not shown) for read/write operations. Conversely, when the leader block 36 is stored in the tape access window 48, the tape access window 48 is covered.

In addition to forming a portion of the tape access window 48, the second housing section 42 also forms a central opening 50. The central opening 50 facilitates access to the tape reel assembly 26 by a drive chuck of the tape drive (neither shown). During use, the drive chuck enters the central opening 50 to disengage the brake assembly 24 prior to rotating the tape reel assembly 26 for access to the storage tape 28. The brake assembly 24 is of a type known in the art and generally includes a brake body 52 and a spring 54 co-axially disposed within the tape reel assembly 26. When the data storage tape cartridge 20 is idle, the brake assembly 24 is engaged with a brake interface 56 to selectively “lock” the tape reel assembly 26 to the housing 22.

The tape reel assembly 26 includes a hub 60, an upper flange 62, and a lower flange 64. The hub 60 defines a tape-winding surface (not visible in FIG. 1 due to the presence of the storage tape 28) about which the storage tape 28 is wound. The flanges 62, 64 are optional. For example, in one embodiment the storage tape 28 is wound about a flangeless hub such that the tape reel assembly 26 comprises only the flangeless hub. When the flanges 62, 64 are provided, they are coupled to opposing ends of the hub 60 and extend in a radial direction from the hub 60. It is desired that the flanges 62, 64 be spaced a distance apart that is slightly greater than a width of the storage tape 28. In this manner, the flanges 62, 64 are adapted to guide and collate the storage tape 28 as it is wound onto the hub 60.

The storage tape 28 is preferably a magnetic tape of a type commonly known in the art. For example, the storage tape 28 can be a balanced polyethylene naphthalate (PEN) based substrate coated on one side with a layer of magnetic material dispersed within a suitable binder system, and coated on the other side with a conductive material dispersed within a suitable binder system. Acceptable magnetic tape is available, for example, from Imation Corp., of Oakdale, Minn.

The leader block 36 covers the tape access window 48 during storage of the cartridge 20 and facilitates retrieval of the storage tape 28 for read/write operations. In general terms, the leader block 36 is shaped to conform to the window 48 of the housing 22 and to cooperate with the tape drive (not shown) by providing a grasping surface for the tape drive to manipulate in delivering the storage tape 28 to the read/write head. In this regard, the leader block 36 can be replaced by other components, such as a dumb-bell shaped pin. Moreover, the leader block 36, or a similar component, can be eliminated entirely, as is the case with dual reel cartridge designs.

As a point of reference, the tape reel assembly 26 and the storage tape 28 have been described above as one form of data storage media. However, it is to be understood that other forms of data storage media are equally acceptable. For example, the data storage media can include magnetic discs, optical tapes, optical discs, and any non-volatile data storage device configured to be disposed within the enclosed region 44.

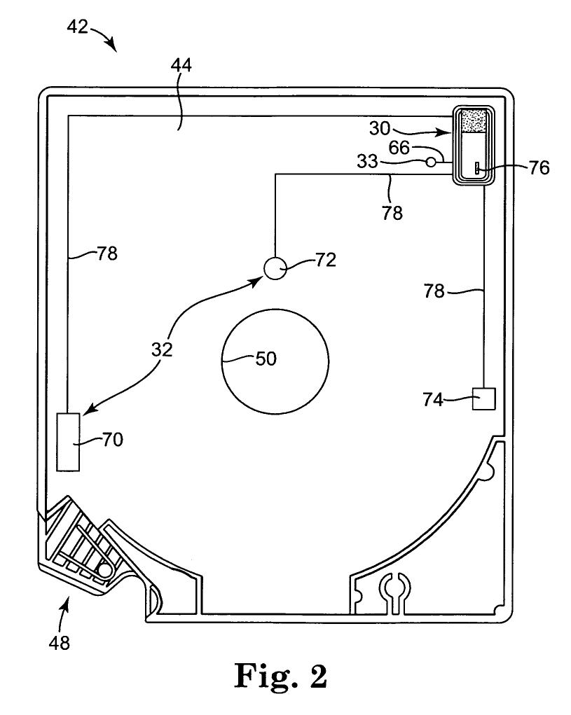

FIG. 2 is a top view of the second housing section 42 showing the memory module 30, the sensors 32, and the power source 33 disposed in the enclosed region 44. The power source 33 is electrically coupled to the memory module by an electrical lead 66. In one embodiment, the power source 33 is a battery, for example a lithium battery, adapted to power the memory module 30 and/or the sensors 32 when a cartridge event is sensed. In a preferred embodiment, the power source 33 is a rechargeable battery adapted to power the cartridge 20 over its life cycle. In this regard, the rechargeable battery is recharged when data is read from the storage tape 28, and/or when data is read from the memory module 30 as described below, and/or at a specified required time interval. In an alternate embodiment, the sensors 32 are passive sensors and the power source 33 is optional and not provided. However, as a point of reference, passive sensors are not powered, and in the absence of the power source 33, the passive sensors of the alternate embodiment are “one-time” sensors capable of a single reading, for example a single reading of a shock sensed due to a dropping of the cartridge 20 during shipping. With this in mind, in a preferred embodiment the power source 33 is a rechargeable power source electrically coupled to the memory module by the electrical lead 66.

The one or more sensors 32 can assume a wide variety of forms and perform a wide variety of functions. In one embodiment, the sensors 32 include a door sensor 70 for sensing removal of the leader block 36 (FIG. 1) from the tape access window 48, a tape rotation sensor 72 for sensing movement of the storage tape 28 (FIG. 1), a temperature sensor 74, and an acceleration sensor 76. The sensors 70, 72, 74, 76 are electrically coupled to the memory module 30 by electrical connectors 78. In general, the sensors 70, 72, 74, and 76 can be optical sensors, mechanical sensors, and/or micro-electronic mechanical system (MEMS) sensors, and can be disposed at any location throughout the enclosed region 44. With regard to the acceleration sensor 76, in one embodiment the acceleration sensor 76 is disposed directly onto the memory module 30 and electrically coupled thereto by an electrical connector that is not visible in the view shown in FIG. 2. With this in mind, the illustrated positions of the sensors 70, 72, 74, and 76 represent but one possible placement configuration, and it is understood that other placement configurations for some or all of the sensors 70, 72, 74, and 76 and/or additional sensors 32 in the enclosed region 44, or on the cartridge 20 (FIG. 1), are equally acceptable.

The electrical connectors 78 extend from the memory module 30 to a respective one of the sensors 70, 72, 74, and 76. In one embodiment, the electrical connector 78 is a metal wire. In an alternate embodiment, the electrical connector 78 is printed, conductive ink extending continuously between the memory module 30 and a respective one of the sensors 70, 72, 74, and 76.

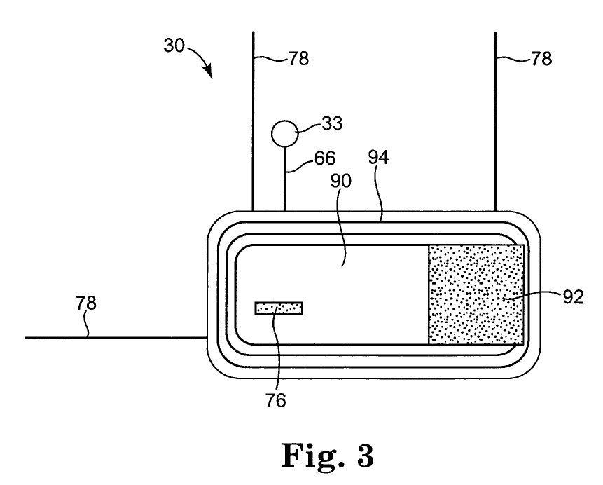

FIG. 3 is a top view of the memory module 30 illustrated in FIG. 2 including the acceleration sensor 76. The memory module 30 includes a backing 90, a memory chip 92, and an antenna 94. The memory module 30 is disposed inside the housing 22 (FIG. 1) in any location that does not interfere with operation of the moving parts of the cartridge 20 (FIG. 1). The backing 90 is a substrate configured to retain the memory chip 92 and the antenna 94. In this regard, the backing 90 is a carrier for the chip 92 and the antenna 94 components, and in one embodiment is rigid and is referred to as a printed circuit board backing. In an alternate embodiment, the backing 90 is a flexible film backing onto which the chip 92 and the antenna 94 components are laminated prior to adhesively attaching the backing 90 to the enclosed region 44 (FIG. 1). In any regard, the backing 90 retains the electrical features (such as pads, metal-plated holes, wire bonding, etc.) necessary to couple the memory module 30 to the electrical connectors 78 that extend away from the backing 90 to a respective one of the sensors 70, 72, 74, and 76 (FIG. 2).

The memory chip 92 electronically records and stores data (i.e., sensed cartridge events) generated by the sensors 70, 72, 74, and 76 (FIG. 2). The memory chip 92 is configured to date and time stamp the cartridge events sensed by the sensors 70, 72, 74, and 76, thus establishing a chronological performance record of cartridge events. To this end, the memory chip 92 is preferably an electronic memory chip having read/write memory capability such that the memory can be erased and rewritten. In addition, the memory chip 92 is also preferably an electronic memory chip that retains stored data even in a power “off” condition. In one embodiment, the memory chip 92 is a 4 k-byte electrically erasable programmable read-only memory (EEPROM) chip known as an EEPROM chip available from, for example, Philips Semiconductors, Eindhoven, The Netherlands. In an alternate embodiment, the memory chip 92 is an 8 k-byte EEPROM chip available from Philips Semiconductors. In another alternate embodiment, the memory chip 92 is configured for increased data storage and is a 32 k-byte EEPROM chip. In a preferred embodiment, the memory chip 92 is a radio frequency memory chip as used in radio frequency identification (RFID) tags. In this embodiment, the chip 92 includes a radio frequency interface (not shown) to support contactless access with the memory. In any regard, the memory chip 92 is configured to record cartridge events sensed by the sensors 70, 72, 74, and/or 76 as data in a performance record.

The antenna 94, in one embodiment, is disposed about a perimeter of the memory module 30 and is shown as coiled in triplicate in FIG. 3. That is to say, the antenna 94 is a coiled antenna disposed about a periphery of the memory module 30. In a preferred embodiment, the antenna 94 is a coiled copper radio frequency (RF) antenna. In an alternate embodiment, the antenna 94 is integrated onto the chip 92. In any regard, it is to be understood that other materials for, and various forms of, the antenna 94 are also acceptable. With this in mind, the RF antenna 94 is adapted to communicate information stored on the memory chip 92 such that the memory module 30 is a transponder module.

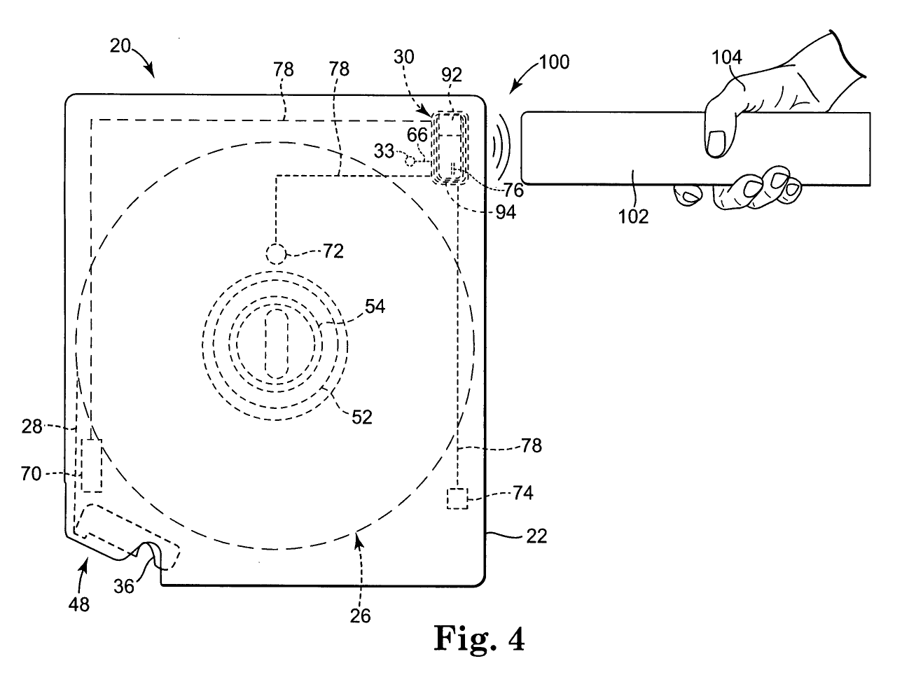

FIG. 4 illustrates a system 100 for generating a performance record for a data storage device according to one embodiment of the present invention. The system 100 includes a data storage cartridge in the form of the data storage tape cartridge 20 and includes the memory module 30 electrically coupled to at least one sensor, for example the door sensor 70, and a reader 102. In a preferred embodiment, the reader 102 is operated by a user 104 such that the performance record is read without having to open the data storage tape cartridge 20. The memory module 30 includes the antenna 94 that is configured to communicate information, for example a sensed cartridge event sensed by the sensor 70 and recorded and stored by the memory chip 92, to the reader 102. In one embodiment, the information stored in the memory chip 92 includes sensed cartridge events such as a cartridge temperature, humidity, magnetic disturbances, acceleration, shock, stress, vibration, an opening of the cartridge housing 22, revolutions of the tape reel assembly 26, read/write operations to the storage tape 28, and readings of the memory module 30. To this end, the information is stored by the memory chip 92 and date/time stamped to form the performance record indicative of past performance and use of the data storage tape cartridge 20. In a preferred embodiment, the antenna 94 communicates the performance record data wirelessly (i.e., contactlessly) via radio frequency (RF) to the reader 102, and the reader 102 in turn recharges the power source 33. In this regard, the memory module 30 is a transponder and the reader 102 is a handheld RF transceiver.

In contrast with the known data storage cartridges, the data storage tape cartridge 20 and the system 100 of the present invention includes at least one sensor, for example sensors 70, 72, 74, and 76, for sensing cartridge events that are stored in a performance record, and the module 30 configured to communicate the performance record data to the reader 102. In a preferred embodiment, the memory chip 92 date/time stamps each sensed cartridge event, thus enabling the user 104 to access the performance record and determine whether the cartridge 20 has been tampered with and/or subjected to conditions likely to cause damage, and the antenna 94 communicates the performance record to a location exterior the cartridge 20, preferably to the handheld RF reader 102.

An exemplary process of generating a performance record for a data storage device is described with reference to FIG. 4. Once again, the data storage tape cartridge 20 is shown and includes the housing 22 maintaining the tape reel assembly 26, the memory module 30, and at least one sensor, for example, the door sensor 70. The door sensor 70 is disposed adjacent to the tape access window 48 and is electrically coupled to the memory module 30 via the electrical connector 78. To this end, the door sensor 70 is configured to sense a presence of a properly stored leader block 36 in the tape access window 48. In particular, the door sensor 70 senses, and the memory chip 92 records and date/time stamps, a removal of the leader block 36 from the tape access window 48 by a drive system (not shown) during a read/write process. In this example, sensing the absence of the leader block 36 in the tape access window 48 is a cartridge event, and storing data related to the sensed cartridge event in the memory chip 92 generates the performance record which is indicative of the prior use of the data storage tape cartridge 20.

The past performance and use of the data storage tape cartridge 20, in the form of data compiled in the performance record, is stored in the memory module 30 by the memory chip 92. In a preferred embodiment, the memory chip 92 electronically records and date/time stamps the cartridge events, thus compiling a record that can be reviewed for evidence of tampering with, and/or abuse to, the cartridge 20. The user 104 through the use of a reader 102 can selectively read the performance record without opening the housing 22.

The reader 102 can be employed to query past use and read the performance record of the data storage tape cartridge 20. In addition, the reader 102 also recharges the power source 33 during the query/read step. In particular, in one embodiment the reader 102 can be placed adjacent to the cartridge 20 by the user 104 for reception of a RF signal communicated from the antenna 94. For example, the sensor 74 is a temperature sensor that senses a local temperature of the cartridge 20. The memory chip 92 records the sensed cartridge event of temperature, for example the temperature of the cartridge 20 over the previous year. In addition, the memory chip 92 records and date/time stamps when the cartridge 20 temperature drops below a selected value, and also, when the cartridge 20 temperature rises above the same selected value. These temperature data are stored in the memory chip 92 of the memory module 30, and when date/time stamped, form a chronological performance record of temperature data for the cartridge 20. In a similar manner, the memory module 30 records and compiles data over a period of time for one or more sensors 32 (FIG. 1) sensing a variety of cartridge events. This stored data, or sensed cartridge events, is communicated from the memory module 30 via the antenna 94 to the reader 102. Concurrent with the reader 102 receiving the sensed cartridge events from the memory module 30, the reader 102 also recharges the power source 33, for example via RF energy transmission.

In another exemplary query, the data storage tape cartridge 20 is stored between uses, and access to the stored cartridge 20 is restricted. As a point of reference, the data storage tape cartridge 20 is suited for so-called “top-secret” uses, where confidential commercial data or restricted governmental data is stored on the storage tape 28. In this exemplary query, the user 104 has an interest in monitoring past access to the storage tape 28 in determining if restricted access to the data stored on the storage tape 28 has been breached. To this end, the reader 102 is employed to query the memory module 30 for past access to the storage tape 28. Recall, the tape rotation sensor 72 has been described as being configured to sense movement of the storage tape 28, as would occur during any read/write process. Consequently, when the reader 102 queries the memory module 30 for sensed cartridge events related to the tape rotation sensor 72, the reader 102 is essentially monitoring rotation and movement of the tape reel assembly 26 and/or prior access to the storage tape 28. In this manner, the user 104 employing the reader 102 can monitor the date and time of any prior cartridge 20 activities by reviewing the performance record which will indicate any prior access to the storage tape 28 (and therefore, access to information on the storage tape 28). If the user 104 determines after reviewing the performance record that the storage tape 28 has been accessed without authorization, the user 104 is alerted to the possibility that the data stored on the storage tape 28 could be tainted, or that a breach in security has occurred. Therefore, the performance record serves as a safety and security check relative to storage tape 28 accesses.

Although specific embodiments of a data storage cartridge having sensors, and a memory module for generating a performance record have been illustrated and described in this written description, it will be appreciated by those of ordinary skill in the art that a variety of alternate and/or equivalent implementations may be substituted for the specific embodiments shown and described without departing from the scope of the present invention. With this in mind, this application is intended to cover any adaptations or variations of data storage cartridges having a memory module and at least one sensor. Therefore, it is intended that this invention be limited only by the claims and their equivalents.

What is claimed is:

1. A data storage cartridge comprising:
a housing defining first and second housing sections, the housing sections reciprocally mated to form an enclosed region;
a data storage medium disposed within the enclosed region;
a memory module disposed within the enclosed region; and
at least one sensor disposed within the enclosed region and electrically coupled to the memory module, the at least one sensor configured to sense a cartridge event;
wherein the memory module communicates with the at least one sensor to record the sensed cartridge event.

2. The data storage cartridge of claim 1, wherein the data storage medium includes magnetic data storage tape wound about a tape reel.

3. The data storage cartridge of claim 1, further comprising:
a power source electrically coupled to the memory module; and
a memory chip electrically coupled to the memory module and configured to record the sensed cartridge event as data in a performance record.

4. The data storage cartridge of claim 1, wherein the memory module is configured to associate a time stamp with the sensed cartridge event.

5. The data storage cartridge of claim 1, wherein the memory module is a radio frequency memory module.

6. The data storage cartridge of claim 1, wherein the memory module includes an antenna configured to communicate the recorded sensed cartridge event wirelessly to a reader external of the housing.

7. The data storage cartridge of claim 1, wherein the cartridge event includes at least one of a cartridge temperature, humidity, magnetic disturbance, acceleration, shock, stress, vibration, a housing opening, reading from the data storage medium, writing to the data storage medium, and a reading of the memory module.

8. The data storage cartridge of claim 1, wherein the at least one sensor is selected from the group consisting of a temperature sensor, an acceleration sensor, a stress sensor, a vibration sensor, an optical sensor, a mechanical sensor, a MEMS sensor, a magnetic field sensor, a radio frequency sensor, a pressure sensor, and a data storage medium drive sensor.

9. The data storage cartridge of claim 1, wherein the at least one sensor is electrically coupled to the memory module by conductive ink.

10. The data storage cartridge of claim 1, wherein the at least one sensor is disposed on the memory module.

11. The data storage cartridge of claim 1, wherein a plurality of sensors is disposed within the enclosed region and electrically coupled to the memory module, the plurality of sensors configured to sense a plurality of cartridge events and the memory module configured to record the sensed cartridge events.

12. The data storage cartridge of claim 1, wherein the data storage medium disposed within the enclosed region is separate from the memory module disposed within the enclosed region.

13. A system for generating a performance record for a data storage device, the system comprising:
a data storage cartridge including:
a housing defining first and second housing sections, the housing sections reciprocally mated to form an enclosed region,
a data storage medium disposed within the enclosed region,
a memory module disposed within the enclosed region,
at least one sensor disposed within the enclosed region and electrically coupled to the memory module, the at least one sensor configured to sense a cartridge event; and
a reader;
wherein the memory module is configured to store the sensed cartridge event in the performance record, and further wherein the reader communicates with the memory module to read the performance record.

14. The system of claim 13, wherein the data storage cartridge is a data storage tape cartridge including a magnetic tape wound about a tape reel disposed within the housing.

15. The system of claim 13, wherein the memory module includes an antenna configured to communicate the performance record to the reader.

16. The system of claim 13, wherein the memory module includes a radio frequency memory chip configured to associate a time stamp with each sensed cartridge event.

17. A method of generating a performance record for a data storage device, the method comprising:
providing a data storage cartridge including:
a housing defining first and second housing sections, the housing sections reciprocally mated to form an enclosed region,
a data storage medium disposed within the enclosed region,
a memory module disposed within the enclosed region,
at least one sensor disposed within the enclosed region and electrically coupled to the memory module;
sensing a cartridge event with the at least one sensor;
storing the sensed cartridge event in the memory module as data in the performance record; and
reading the performance record data with a reader located exterior to the data storage cartridge.

18. The method of claim 17, wherein sensing a cartridge event includes sensing at least one of a cartridge temperature, humidity, magnetic disturbance, acceleration, shock, stress, vibration, a housing opening, reading from the data storage medium, writing to the data storage medium, and a reading of the memory module.

19. The method of claim 17, wherein reading the performance record data includes wirelessly communicating the performance record data from the memory module to a radio frequency handheld reader.

20. The method of claim 17, wherein storing the sensed cartridge event in the memory module includes electronically time stamping each sensed cartridge event and storing the time stamped data in the memory module.
